(19) United States
(12) Patent Application Publication
(10) Pub. No.: US 2026/0357856 A1
(43) Pub. Date: Nov. 12, 2026

(54) CLUTCH ASSEMBLY AND ELECTRIC DRIVETRAIN HAVING THE CLUTCH ASSEMBLY

(71) Applicant: Schaeffler Technologies AG & Co. KG, Herzogenaurach (DE)

(72) Inventors: Marvin Hofmann, Ettlingen (DE); Markus Kohler, Bad Windsheim (DE); Markus Heitbaum, Bühlertal (DE)

(73) Assignee: Schaeffler Technologies AG & Co. KG, Herzogenaurach (DE)

(21) Appl. No.: 19/139,870

(22) PCT Filed: Nov. 13, 2023
(86) PCT No.: PCT/DE2023/100865

§ 371 Date: Jun. 17, 2025

(30) Foreign Application Priority Data
Dec. 19, 2022 (DE) 10 2022 133 795.2

(51) Int. Cl. F16D 25/08; F16D 25/12; F16D 125/04

(52) U.S. Cl. CPC F16D 25/083; F16D 25/126; F16D 2125/04

(57) ABSTRACT

A clutch assembly includes a clutch housing, a clutch device, arranged in the clutch housing, for coupling a first coupling partner with a second coupling partner for conjoint rotation, a slave cylinder, arranged in the clutch housing, for actuating the clutch device, and a fastening device. The slave cylinder includes a main axis, a cylinder housing including a fastening portion, and a piston arranged in the cylinder housing and axially movable relative to the main axis to transmit an actuating force to the clutch device. The fastening device is arranged for clamping the fastening portion on the clutch housing.

### CROSS-REFERENCE TO RELATED APPLICATIONS

This application is the United States National Phase of PCT Appln. No. PCT/DE2023/100865 filed Nov. 13, 2023, which claims priority to German Application No. DE102022133795.2 filed Dec. 19, 2022, the entire disclosures of which are incorporated by reference herein.

### TECHNICAL FIELD

The present disclosure relates to a clutch assembly and an electric drivetrain including the clutch assembly.

### BACKGROUND

Clutches are known for engaging and disengaging an electric machine in a drivetrain of a motor vehicle. To open and close the clutch, a clutch slave cylinder is required, which has a housing with a pressure chamber in which an axially displaceable piston is guided. The housing of the clutch slave cylinder is in turn screwed to a housing of the clutch assembly via at least two fastening lugs.

The publication DE 197 55 494 A1 discloses a release device for a hydraulically actuated friction clutch of vehicles, including a slave cylinder, with a pressure housing concentrically enclosing a drive shaft, in which an annular piston which can be acted upon by a pressure medium is displaceably guided, on which a release bearing supported on the friction clutch is arranged at the end. The pressure housing is releasably screwed to a transmission housing and for this purpose is provided with circumferentially distributed fastening sleeves or fastening eyelets, the bore of which serves to accommodate a fastening screw which can be screwed into an associated threaded bore of the transmission housing. Each fastening screw has a retaining lock and the pressure housing is provided with a wall running coaxially to the drive shaft, which encloses the release bearing in a neutral position. The fastening screw is preferably guided with the screw head on the wall, which at the same time serves to accommodate the retaining lock.

### SUMMARY

The present disclosure proposes a clutch assembly having a slave cylinder with simple and cost-effective fastening.

Example embodiments arise from the following description and the appended figures.

The present disclosure provides a clutch assembly which is designed and/or is suitable, in particular, for a drivetrain of a vehicle, e.g., an electric axle. In particular, the clutch assembly serves to interrupt and/or divert a torque path of the drivetrain. The clutch assembly may be used to engage and disengage an electric machine.

The clutch assembly has a clutch device which is designed and/or suitable for the coupling of a first and a second coupling partner for conjoint rotation. In principle, the clutch device can be designed as a positive clutch, in particular a dog clutch. Alternatively, the clutch device can be designed as a friction clutch, in particular a multiple disc clutch. In principle, the first and second coupling partners can each be designed as a shaft, e.g., an engine shaft and a transmission shaft, which are arranged to be coaxial and/or concentric to one another in relation to a main axis. Alternatively, however, one of the two coupling partners can also be designed as a transmission component, e.g., a gear wheel. The main axis may be defined by an axis of rotation of the coupling partners.

Furthermore, the clutch assembly has a slave cylinder which is designed and/or suitable for operating the clutch device. The slave cylinder may be hydraulically actuated. The slave cylinder may be designed as a concentric slave cylinder, (CSC). In particular, the concentric slave cylinder is designed as a central release unit.

The slave cylinder has a cylinder housing and at least or exactly one piston, wherein the piston is arranged in the cylinder housing so as to be movable in the axial direction in relation to the main axis to transmit an actuating force to the clutch device. In particular, the piston is operatively connected to the clutch device, e.g., to an actuating member. The actuating force may be understood as a compressive force directed axially in relation to the main axis. The cylinder housing and the piston may delimit a pressure chamber filled with operating medium. The slave cylinder can be fluidically connected to a hydraulic system which, when actuated, increases the pressure on the operating medium, and the actuating force is generated by the rising pressure in the pressure chamber and transmitted to the piston. In particular, the pressure chamber is formed by a cylindrical chamber, e.g., an annular chamber.

In particular, the cylinder housing is arranged to be coaxial and/or concentric to the main axis. The cylinder housing can be designed as a hollow cylindrical and/or annular housing. The cylinder housing may be designed as an annular housing and the piston as an annular piston, which extend concentrically around the main axis. The annular housing may have a central through-opening, in particular a bore, through which at least one shaft, e.g., the motor shaft, can be guided in an installation situation of the slave cylinder.

The clutch assembly has a clutch housing which is designed and/or suitable for accommodating the clutch device and the slave cylinder. In particular, the clutch housing has a housing chamber, in particular a wet chamber, in which the clutch device and the slave cylinder are arranged. The housing chamber may be delimited in the axial direction in relation to the main axis by a housing wall of the clutch housing, and the first and/or the second coupling partner, in particular the shaft(s), are guided through the housing wall into the housing chamber.

In addition, the clutch assembly has a fastening device which is designed and/or suitable for fastening a component of the clutch assembly to the clutch housing, in particular in a detachable manner. The fastening device is used in particular for form-fitting and/or force-fitting fastening of the component to the clutch housing. In principle, the component can be any functional or housing component of the clutch device and/or the slave cylinder, which must be fixed or fastened to the clutch housing in an intended installation situation.

In the context of the disclosure, it is proposed that the cylinder housing has at least or exactly one fastening portion, which is held at least indirectly by the fastening device in a clamping manner on the clutch housing. In particular, the fastening portion is held in a clamping manner in the axial direction and in the circumferential direction in relation to the main axis between the component fastened by the fastening device and the clutch housing. In particular, the fastening device applies a clamping force to the fastening portion, and a force-fitting connection between the fastening portion and the clutch housing is created by means of the clamping force. The at least one fastening portion can be pressed against the clutch housing in the axial direction in relation to the main axis under the effect of the clamping force, whereby a frictional fit is created between the fastening portion and the clutch housing, which secures the cylinder housing against rotation in the circumferential direction in relation to the main axis.

Slave cylinders, in particular concentric slave cylinders, are usually bolted to housing-fixed attachments or the clutch housing with two or more screw-on lugs. Depending on the number of screw-on lugs, the same number of screws and—in the case of a cylinder housing made of plastic—press-fit sleeves are required.

Clamping attachment of the cylinder housing via an already mounted component of the clutch assembly enables particularly simple and cost-effective assembly, and cost-intensive additional components, such as the screws and press-fit sleeves, can be dispensed with. In addition, the proposed slave cylinder has easy handling and quick assembly, particularly in the assembly process.

In an example embodiment, the fastening device has at least or exactly one screw means, and a clamping force acting on the fastening portion can be adjusted via the screw means. In particular, the clamping force can be adjusted and/or changed depending on the tightening torque of the screw means. For example, the screw means can be tightened to a specified tightening torque to generate a defined clamping force. In particular, the clutch housing has at least or exactly one screw means receptacle, e.g., a threaded bore, via which the screw means is mounted or can be mounted on the clutch housing. The clamping force may be transmitted to the fastening portion via the component fastened by the fastening device. A fastening device with a variable adjustment of the clamping force is proposed.

In a further embodiment, the clutch assembly has a latching device which is designed and/or suitable for latching the piston in at least or exactly one axial piston position. In particular, the piston can be displaced in the axial direction in relation to the main axis between a home position and an actuating position, and the latching device latches the piston in the home position and/or in the actuating position. The latching device may have a latch element for this purpose, e.g., a wire ring, which interacts at least indirectly with the piston. For example, the piston is movement-coupled directly or via a transmission member, e.g., a pressure pot, to an actuating member of the clutch device, and the latch element can be brought into engagement with at least one latch contour of the piston or of the transmission member or of the actuating member.

According to this embodiment, the latching device is fastened to the clutch housing by the fastening device, and the fastening portion is held clamped in the axial direction in relation to the main axis between the latching device and the clutch housing. In other words, the fastening portion is supported in the axial direction in relation to the main axis on the latching device on the one hand, and on the clutch housing on the other. This allows the cylinder housing to be easily attached or held in place on the latching device, which is already mounted on the clutch housing.

In one embodiment, the latching device is provided with at least or exactly one support plate, which is attached to the cylinder housing via the fastening device. In particular, the support plate serves to axially support and/or accommodate the latch element. The latching device may have a further support plate, and the latch element is held in the axial direction in relation to the main axis between the two support plates. For this purpose, the two support plates can be fastened together to the clutch housing via the fastening device, e.g., the screw means, and the two support plates are axially spaced apart from each other at least in sections to accommodate the latch element.

According to this embodiment, the support plate provides a support surface in an axial direction in relation to the main axis for the axial support of the fastening portion. In particular, the fastening portion is supported at least in sections and/or regions in the axial direction on the support surface. The support plate may be fixed to the clutch housing in the axial direction in relation to the main axis in a form-fitting and/or force-fitting manner by the screw means. For example, the support plate is designed as a flat sheet metal component that extends substantially in a radial plane of the main axis. The support plate can be designed as a support ring or a support ring segment, which is arranged to be coaxial to the main axis in particular. In other words, the support surface is designed as an annular surface or an annular segment surface surrounding the main axis. In particular, the clamping force can be evenly distributed over the fastening portion via the support plate or the support surface. This suggests a particularly secure fastening or clamping of the fastening portion.

In a further embodiment, the clutch housing has a support portion which is designed and/or suitable for supporting the fastening portion. For this purpose, the support portion provides a further support surface in an opposite axial direction in relation to the main axis, for axial support of the fastening portion. In particular, the fastening portion is supported at least in sections and/or regions in the opposite axial direction on the further support surface. In particular, the support portion is formed by an annular shoulder surrounding the main axis, which extends substantially in a radial plane of the main axis. The support surface and the further support surface may form two opposing surfaces in the axial direction, between which the fastening portion is held in a clamping manner. A clutch housing is therefore proposed which is suitable for simple fastening the fastening portion in a clamping manner.

In an example embodiment, the at least or exactly one fastening portion is arranged on an outer circumference of the cylinder housing, and the at least one fastening portion is offset outwards in the radial direction in relation to the main axis relative to the outer circumference, forming a radial shoulder. In other words, the at least one fastening portion protrudes from the outer circumference at least in the radial direction and optionally in the axial direction in relation to the main axis. In particular, the cylinder housing has more than two, more than four, or more than six of the fastening portions, and the fastening portions are spaced apart in the circumferential direction in relation to the main axis. The fastening portions may be formed in one piece, in particular from a common material section, on a base body of the cylinder housing. The at least one fastening portion is supported in an axial direction with an axial end face on the support surface of the support plate and in an opposite axial direction with the shoulder on the further support surface of the clutch housing. A cylinder housing is thus proposed which can be easily fixed to the outer circumference of the clutch housing via one or more fastening portions.

In a further development, the fastening portion has a clamping geometry on at least or exactly one axial end face, which is designed to be deformable to compensate for tolerances. In particular, the clamping geometry defines an axial oversize in relation to an axial distance between the two support surfaces, whereby an oversize press-fit of the fastening portion between the two support surfaces is created in an assembled state. In particular, the clamping geometry is deformable under the effect of the clamping force. The clamping geometry may be deformed or warped during fastening, in particular when tightening the at least one screw means. The clamping geometry therefore allows the clamping fastening to be further optimized. The clamping geometry also makes it easy to compensate for tolerances.

In a further embodiment, the clamping geometry is formed by a plurality of clamping lugs aligned in the axial direction in relation to the main axis. In particular, the clamping lugs are formed on the axial end face and/or on the shoulder of the fastening portion. The clamping lugs may be arranged on the axial end face of the fastening portion, whereas the fastening portion with the shoulder lies flat, e.g., over the entire surface of the clutch housing, in particular the further support surface. The clamping geometry may have more than two, more than four, or more than six clamping lugs. In particular, the clamping lugs are plastically deformable when fastened. This ensures a particularly high frictional fit between the cylinder housing and the clutch housing.

In a further embodiment, at least the fastening portion, e.g., the entire cylinder housing, is made of a plastics material. In particular, the fastening portion or the cylinder housing is made of a polymer material. At least the fastening portion may be made of a softer material than the support plate and the clutch housing, so that a deformation resulting from the clamping force acting on the fastening portion, e.g., the clamping geometry, occurs. A cylinder housing is thus proposed which is distinguished by particularly secure fixing. In addition, a cylinder housing with a light component weight is proposed.

The present disclosure also relates to an electric drivetrain having the clutch assembly as previously described. The electric drivetrain serves in particular to create and/or provide a traction torque, in particular a main traction torque, for the vehicle. The drivetrain may have an electric machine, in particular an electric motor, which is used to generate and/or provide the traction torque. Optionally, the electric drivetrain can also have an internal combustion engine, in particular a combustion engine, which is used to provide further traction torque for the vehicle.

Alternatively or optionally, the drive system additionally has a transmission device which serves to transmit the traction torque. The transmission device can, for example, be designed as a single-stage or multi-stage transmission, a stepped automatic transmission, a dual-clutch transmission or a continuously variable transmission, e.g., CVT transmission.

The electric machine may have a first shaft, in particular a motor shaft, which is connected to the electric machine for drive purposes. The internal combustion engine can have a second shaft, in particular a further motor shaft, which is connected to the internal combustion engine for drive purposes. The clutch device may form a disconnect clutch for coupling the electric motor to the internal combustion engine. In particular, the disconnect clutch has the function of disengaging the internal combustion engine so that the electric motor can also be used to drive the vehicle independently of the internal combustion engine.

Alternatively, the second shaft can form a transmission shaft of the transmission device, and the second shaft is connected to the transmission device for transmission purposes. The clutch device can, for example, be designed as a triple clutch system, and the clutch device forms a disconnect clutch (K0) or a dual clutch (K1/K2) of the triple clutch system. In particular, the first and second clutches (K1/K2) have the function of engaging or disengaging the combustion engine and/or the electric motor with the transmission device as required.

### BRIEF DESCRIPTION OF THE DRAWINGS

Further features, advantages and effects of the disclosure arise from the following description of exemplary embodiments. In the drawings:

FIG. 1 shows a schematic sectional view of an electric drivetrain having a clutch assembly as an exemplary embodiment of the disclosure;

FIG. 2 shows a detailed view of the clutch assembly from FIG. 1; and

FIG. 3 shows a perspective detail view of a cylinder housing of the clutch assembly from FIG. 2.

### DETAILED DESCRIPTION

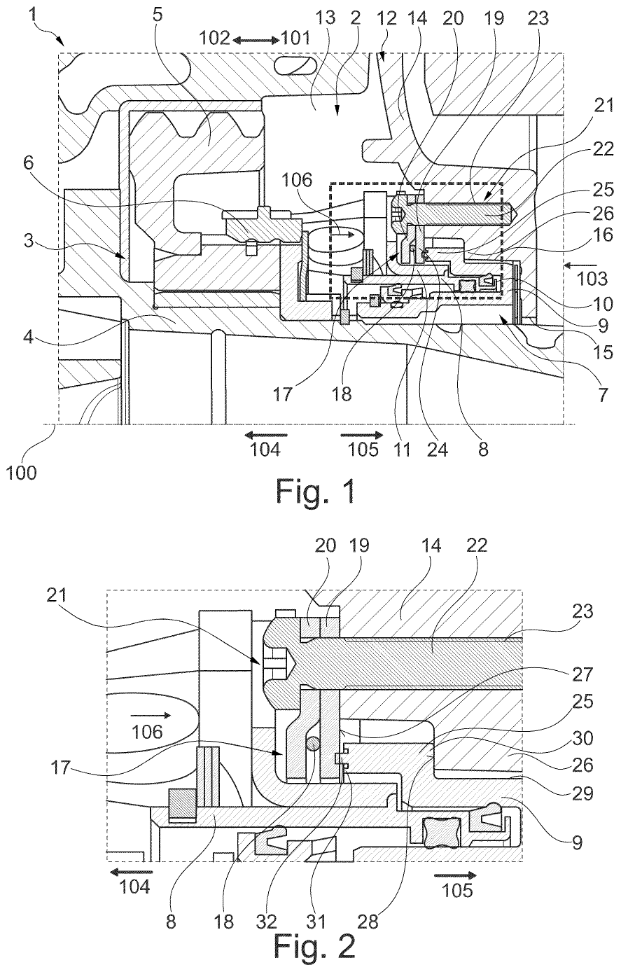

FIG. 1 shows a schematic sectional view of a detailed view of an electric drivetrain 1 having a clutch assembly 2 as an exemplary embodiment. The electric drivetrain 1 is designed as an electric axle, for example, which is used to provide traction torque for a vehicle. The vehicle, not shown, can for example be designed as a single-axle or multi-axle and/or single-track or multi-track electric or hybrid vehicle.

The clutch assembly 2 has a clutch device 3, which is used to couple a first and a second coupling partner 4, 5 for conjoint rotation. For example, the first coupling partner 4 is designed as a motor shaft of an electric machine, not shown, which is used to generate the drive torque, in particular the traction torque. For example, the second coupling partner 5 is a gear wheel of a transmission, not shown, which is used to transmit the drive torque. The first and second coupling partners 4, 5 define a common main axis 100 with their axes of rotation, or are arranged to be coaxial to one another in relation to the main axis 100.

The clutch device 3 has an actuating member 6, which can be moved in the axial direction in relation to the main axis 100 between a home position 101 and an actuating position 102. The two coupling partners 4, 5 are coupled to each other for conjoint rotation in the home position 101 and uncoupled from each other in the actuation position 102. For example, the clutch device 2 is designed as a dog clutch, and the actuating member 6 is designed as a sliding sleeve, via which the two coupling partners 4, 5 are or can be brought into engagement with each other.

To actuate the clutch device 3, the clutch assembly 2 has a hydraulically actuated slave cylinder 7. For example, the slave cylinder 7 is connected to a hydraulic system, not shown, via a hydraulic line, and a hydraulic actuating force 103 is transmitted via the slave cylinder 7 to the actuating member 6 during actuation to move it from the home position 101 to the actuating position 102. For example, the slave cylinder 7 is designed as a concentric slave cylinder (CSC), which is arranged to be coaxial and/or concentric to the main axis 100.

For this purpose, the slave cylinder 7 has at least one piston 8 designed as an annular piston and a cylinder housing 9 designed as an annular housing, and the piston 8 is accommodated in the cylinder housing 9 so as to be displaceable in the axial direction in relation to the main axis 100. The piston 8 and the cylinder housing 9 delimit a pressure chamber 10 that surrounds the main axis 100 and is fluidically connected to the hydraulic system.

To transmit the actuating force 103, the piston 8 is movement-coupled to the actuating member 6 via a transmission member 11. The actuating force 103 is to be understood as a compressive force directed in an axial direction 104 in relation to the main axis 100. For example, the transmission member 11 is designed as a pressure pot.

The clutch assembly 2 includes a clutch housing 12, which serves to accommodate the clutch device 3 and the slave cylinder 7. The clutch housing 12 has a housing chamber 13, which is delimited in an opposite axial direction 105 by a housing wall 14 of the clutch housing 12. The clutch device 3 and the slave cylinder 7 are arranged in the housing chamber 13.

The housing wall 14 has a central opening 15, and the first coupling partner 4, designed as a motor shaft, is guided through the housing wall 14 into the housing chamber 13 via the opening 15. In addition, the housing wall 14 has an annular receptacle 16, in which the cylinder housing 9, which is designed as an annular housing, is accommodated.

Furthermore, the clutch assembly 2 has a latching device 17, which is used to latch the piston 8 in the home position 101 and/or in the actuation position 102. For this purpose, the latching device 17 has a latch element 18 in the form of a wire ring which, in the respective piston position 101, 102, can be brought into engagement with a latch contour, not shown, formed for example on the transmission member 11.

The latching device 17 also has a support plate 19 and a further support plate 20, which are fastened together to the housing wall 14 via a fastening device 21. For this purpose, the fastening device 21 has at least one screw means 22, which is accommodated or screwed into a screw means receptacle 23, e.g., a threaded bore, formed in the housing wall 14. The support plates 19, 20 are fastened to the housing wall 14 in an outer circumferential region in the opposite axial direction 105 via the screw means 22 and are axially spaced apart from one another in an inner circumferential region, forming a gap 24. The latch element 18 is engaged in a form-fitting manner between the two support plates 19, 20 in the gap 21.

The cylinder housing 9 has one or more fastening portions 25 on the outer circumference, which serve to fasten the cylinder housing 9 to the clutch housing 12 or the housing wall 14. For this purpose, the fastening portion 25 is arranged in the axial direction in relation to the main axis 100 between the latching device 17 and the fastening portion 12. For this purpose, the fastening device 21 applies a clamping force 106 to the fastening portion 25 in the opposite axial direction 105, thereby creating a force-fitting connection between the fastening portion 25 and the housing wall 14. For example, the clamping force 106 can be adjusted by a tightening torque of the screw means 22.

The housing wall 14 has a support portion 26, which serves to axially support the fastening portion 25. In the assembled state, the fastening portion 25 is thus supported in the axial direction 104 on the support plate 19 and in the opposite axial direction 105 on the support portion 26 of the housing wall 14, and a force-fitting connection is formed between the fastening portion 25 and the clutch housing 12 or the housing wall 14 by the clamping force 106.

FIG. 2 shows a detailed representation of the clutch assembly 2 as indicated in FIG. 1. The support plate 19 is designed, for example, as a support ring surrounding the main axis 100, which provides a support surface 27 surrounding the main axis 100 for supporting the fastening portion 17 in the axial direction 104. The support surface 25 extends substantially in a radial plane of the main axis 100.

The support portion 26 is designed, for example, as an annular shoulder surrounding the main axis 100, which provides a further support surface 28 surrounding the main axis 100 for supporting the fastening portion 17 in the opposite axial direction 105. The further support surface 28 extends substantially in a further radial plane of the main axis 100. The two support surfaces 27, 28 are thus to be understood as two axially opposing surfaces, between which the fastening portion 25 is accomodated in a clamping manner.

The fastening portion 25 is offset in the radial direction in relation to the main axis 100 relative to an outer circumference 29 of the cylinder housing 9, forming a radial shoulder 30, and the fastening portion 25 is supported with the shoulder 30 on the support portion 26 of the housing wall 14, in particular the support surface 28.

Furthermore, the fastening portion 25 has a clamping geometry 32 on an axial end face 31 which serves to compensate for tolerances. Due to the clamping geometry 32, the fastening portion 25 has an axial oversize in relation to an axial distance between the two support surfaces 27, 28, and the clamping geometry 32 is deformable, in particular plastically deformable, when the latching device 17 is mounted by the fastening device 21. For example, the cylinder housing 9 is made of a polymer material for this purpose. In the assembled state, the fastening portion 25 is thus supported in the axial direction 104 with the clamping geometry 32 on the support surface 27 and in the opposite axial direction 105 with the shoulder 28 on the further support surface 28, forming a frictional fit.

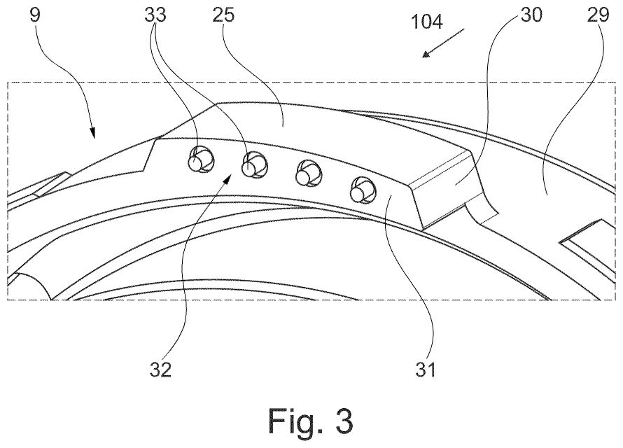

FIG. 3 shows a detailed perspective view of the cylinder housing 9. The fastening portion 25 is formed in sections in the circumferential direction, and the cylinder housing 9 has, for example, a plurality of the fastening portions 25, which are evenly spaced from one another in the circumferential direction. The clamping geometry 32 is formed by four clamping lugs 33, which are formed on the end face 31 of the fastening portion 25 in the axial direction 104. The clamping lugs 33 are aligned in the same direction to one another, and the clamping lugs 33 are supported together on the support surface 27 of the support plate 19 in the assembled state.

### REFERENCE NUMERALS

1 Electric drivetrain
2 Clutch assembly
3 Clutch device
4 First coupling partner
5 Second coupling partner
6 Actuating member
7 Slave cylinder
8 Piston
9 Cylinder housing
10 Pressure chamber
11 Transmission member
12 Clutch housing
13 Housing chamber
14 Housing wall
15 Opening
16 Receptacle
17 Latching device
18 Latch element
19 Support plate
20 Further support plate
21 Fastening device
22 Screw means
23 Screw means receptacle
24 Gap
25 Fastening portion
26 Support portion
27 Support surface
28 Further support surface
29 Outer circumference
30 Shoulder
31 End face
32 Clamping geometry
33 Clamping lugs
100 Main axis
101 Home position
102 Actuation position
103 Actuating force
104 Axial direction
105 Opposite axial direction
106 Clamping force

1. A clutch assembly, comprising:
a clutch device for coupling a first coupling partner and a second coupling partner for conjoint rotation;
a slave cylinder for actuating the clutch device, the slave cylinder having a cylinder housing and at least one piston, the piston being arranged in the cylinder housing so as to be movable in an axial direction in relation to a main axis to transmit an actuating force to the clutch device;
a clutch housing for accommodating the clutch device and the slave cylinder; and
a fastening device for fastening a component of the clutch assembly to the clutch housing,
wherein
the cylinder housing has at least one fastening portion, which is held in a clamping manner on the clutch housing at least indirectly by the fastening device.

2. The clutch assembly according to claim 1, wherein the fastening device has at least one screw means, wherein a clamping force acting on the fastening portion is adjustable via the screw means.

3. The clutch assembly according to claim 1, further comprising a latching device for latching the piston in at least one axial piston position, wherein the latching device is fastened to the clutch housing by the fastening device and wherein the fastening portion is held in a clamping manner axially in relation to the main axis between the latching device and the clutch housing.

4. The clutch assembly according to claim 3, wherein the latching device has at least one support plate which is fastened to the cylinder housing via the fastening device, wherein the support plate provides a support surface in an axial direction in relation to the main axis for axially supporting the fastening portion.

5. The clutch assembly according to claim 1, wherein the clutch housing has a support portion for supporting the fastening portion, wherein the support portion provides a further support surface in an opposite axial direction in relation to the main axis for axially supporting the fastening portion.

6. The clutch assembly according to claim 5, wherein the at least one fastening portion is arranged on an outer circumference of the cylinder housing, wherein the fastening portion is offset in a radial direction in relation to the main axis with respect to the outer circumference, forming a radial shoulder, wherein the fastening portion is supported in an axial direction with an end face on the further support surface and in an opposite axial direction with the radial shoulder on the further support surface.

7. The clutch assembly according to claim 1, wherein the fastening portion has a deformable clamping geometry on at least one axial end face to compensate for tolerances.

8. The clutch assembly according to claim 7, wherein the deformable clamping geometry is formed by a plurality of clamping lugs axially aligned in relation to the main axis.

9. The clutch assembly according to claim 1, wherein the fastening portion is made of plastic.

10. An electric drivetrain having the clutch assembly according to claim 1.

11. A clutch assembly comprising:
a clutch housing;
a clutch device, arranged in the clutch housing, for coupling a first coupling partner with a second coupling partner for conjoint rotation;
a slave cylinder, arranged in the clutch housing, for actuating the clutch device, the slave cylinder comprising:
a main axis;
a cylinder housing comprising a fastening portion; and
a piston arranged in the cylinder housing and axially movable relative to the main axis to transmit an actuating force to the clutch device; and
a fastening device arranged for clamping the fastening portion on the clutch housing.

12. The clutch assembly of claim 11, wherein the fastening device comprises a screw arranged to adjust a clamping force acting on the fastening portion.

13. The clutch assembly of claim 11, further comprising a latching device fastened to the clutch housing by the fastening device and arranged to latch the piston in an axial piston position, wherein the fastening portion is clamped axially between the latching device and the clutch housing.

14. The clutch assembly of claim 13, wherein the latching device comprises a support plate fastened to the cylinder housing by the fastening device, the support plate comprising a support surface for axially supporting the fastening portion.

15. The clutch assembly of claim 14, wherein the clutch housing comprises a support portion with a further support surface for supporting the fastening portion.

16. The clutch assembly of claim 15, wherein the fastening portion:
is arranged on an outer circumference of the cylinder housing;
comprises an end face supported on the support surface; and
is radially offset relative to the outer circumference, forming a radial shoulder supported on the further support surface.

17. The clutch assembly of claim 11, wherein the fastening portion comprises a deformable clamping geometry.

18. The clutch assembly of claim 17, wherein the deformable clamping geometry is formed by axially aligned clamping lugs.

19. The clutch assembly of claim 11, wherein the fastening portion is made of plastic.
